(19) United States
(12) Patent Application Publication
(10) Pub. No.: US 2012/0324756 A1
(43) Pub. Date: Dec. 27, 2012

(54) DEVICE FOR DRYING BULK GOODS

(75) Inventor: Erhard Fux, Wien (AT)

(73) Assignee: WITTMANN KUNSTSTOFFGERAETE GMBH, Wien (AT)

(21) Appl. No.: 13/582,298

(22) PCT Filed: Mar. 2, 2011
(86) PCT No.: PCT/AT2011/000103

§ 371 Date: Aug. 31, 2012

(30) Foreign Application Priority Data
Mar. 3, 2010 (AT) A 330/2010

(51) Int. Cl. F26B 21/08; F26B 11/08; F26B 3/02

(52) U.S. Cl. 34/473; 34/80; 34/109; 34/131; 34/500

(57) ABSTRACT

The invention relates to a device for drying bulk goods, in particular solids, such as granular materials, powders, grains, films, shreds, or the like, preferably plastic granular material. In order to dry the exhaust air flow (5) exiting the drying silo (9), the drying silo (9), through which an air flow flows, is connected by means of a process fan (11) to a wheel drier (1) that contains a drying or adsorbing agent and that has a rotatable drum (2) having radial cells (21). The individual cells (21) of the drum (2) of the wheel drier (1) are formed by plates, wherein clamping plates (24) of a cell (21) lying against the radial outer (22) and inner (23) jackets of the drum (2) have a U-shaped cross-section and are arranged axially on the inner wall. The legs (25) of the U-shaped clamping plates (24) are tilted outwardly. Separating plates (26) are provided as partitions of the individual cells (21). The separating plates are positioned by the clamping effect of adjacent legs (25) of two U-shaped clamping plates (24) lying against each other and seal off the cells from each other.

### CROSS-REFERENCE TO RELATED APPLICATIONS

The present application is a U.S. National Stage of International Patent Application No. PCT/AT2011/000103 filed Mar. 2, 2011, and claims priority of German Patent Application No. A330/2010 filed Mar. 3, 2010.

### BACKGROUND OF THE INVENTION

1. Field of the Invention

The invention relates to a device for drying bulk goods, in particular solids, such as granular materials, powders, grains, films, shreds, or the like, preferably plastic granular material. A drying silo, through which an air flow flows, is provided and the drying silo for drying the exhaust air flow exiting the drying silo or the returning air is connected by a process fan to a wheel drier that contains a drying or adsorbing agent and that has a rotatable drum having radial cells. The exhaust air flow is dried in the wheel drier, the adsorbent is regenerated and subsequently cooled, and the exhaust air flow can be reintroduced to the drying silo as drying air flow.

2. Discussion of Background Information

Various methods and devices are known for drying the returning air that exits from the drying silo.

DE 36 25 013 A1 shows one of these known methods. In the course of said the known method, the exhaust air exiting from the drying funnel is dried in a drier containing an adsorbing agent and returned to the bulk goods as drying air.

Furthermore, a method and a device for drying and heating air that serves for drying bulk goods is known from DE 197 57 537 A1. The device essentially comprises at least one drying cartridge or drying cell, a downstream air heater, a downstream dry goods chamber or drying silo and a downstream cooling device.

Furthermore, a method for regenerating humidity-laden process air is known from DE 101 18 762 A1. Thereby, the atmospheric air is heated up and introduced to the drying cartridge for regeneration. The subsequent cooling of the drying cartridge is achieved by a partial stream of air diverted from the dried process air.

A method for drying humid air is known from EP 0 712 656 B1, and a method and a device for regenerating an adsorbent, containing in particular humidity, from EP 740 956 A2.

Moreover, a device with multiple chambers for selective adsorption of molecules is known from DE 2 025 205 A1.

A device of the type explained above is known from AT 505 391 B1. In accordance with the device, the exhaust air flow is introduced to a feeding channel that is provided in the wheel drier and connected with the adsorbent, diverted in the wheel drier, conducted through the adsorbent and subsequently diverted again as drying air flow and removed in a discharging channel against the direction of flow in the feeding channel, and introduced to the drying silo. One disadvantage of the wheel drier is that high pressures are necessary due to the high flow resistances resulting from the diversions.

All the abovementioned apparatuses primarily have the disadvantages that the devices require a very complex design and a high consumption of energy for regenerating and drying is given in the case of said methods.

### SUMMARY OF THE EMBODIMENTS

The aim of the invention is to create a device of the type mentioned above that on the one hand avoids the above disadvantages and on the other hand increases, globally seen, the economic efficiency both in the acquisition as well as during operation.

The invention is characterized in that the individual cells of the drum of the wheel drier are formed by plates. Clamping plates of a cell lying against the radial outer and inner jackets of the drum have a U-shaped cross-section and are arranged axially on the inner wall and the legs of the U-shaped clamping plates are tilted outwardly, and separating plates provided as partitions of the individual cells are positioned by the clamping effect of adjacent legs of two U-shaped clamping plates lying against each other and seal off the cells from each other. With this invention, it is for the first time possible to unite a simple structural assembly with most simple material components, namely plates, into an absolutely economical solution with a functionality that also satisfies robust operation. The interior structure of the drum constructed from simple plates is not only subject to low wear, but naturally also requires little maintenance. By positioning the separating plates through the clamping effect, packingless axial sealing of the individual cells is achieved. It is also notable that rational, economic production is possible based on the processing of simple plates using simple sheet metal working machines. Another significant advantage of this plate structure inside the drum must be seen in the fact that all thermal expansions due to the temperature differences are absorbed by the elastic structure of the drum.

Another advantage of this plate structure must be seen in the fact that only the adsorbing agent itself needs to be disposed of on a dump in the event of any operationally necessary replacement of the adsorbent. The drum casing with its inner structure, in which the adsorbent is contained in operation, can be reused again naturally. Based on this refilling, an immense advantage is given in terms of environmental burden. Furthermore, the costs of any such renewal are reduced dramatically of course.

With this invention, impeccable quality with high reliability as well as consistent functionality with ingenious design is combined into optimal economic efficiency.

In accordance with a special embodiment of the invention, an amount of at least three, preferably six, in particular 36 cells are provided. This way, a continuous overall process is enabled in an advantageous way. An optimal constant dew point is achieved throughout the operating time as a result of the small spatial units.

In accordance with a special feature of the invention, the wheel drier is divided into at least three wheel segments. The region of one wheel segment serves for drying or dehumidifying the exhaust air flow, the region of the second wheel segment serves for heating the adsorbent, and the region of the third wheel segment serves for cooling the adsorbent. Due to this division into relevant drum regions, a minimization of the required space is achieved, as intermediate steps interrupting the procedure due to lines to the individual process steps are omitted. In addition, the energy balance of the overall process is also optimized as a result.

In accordance with another special feature of the invention, the drying or dehumidifying region amounts to approximately 240 arc degrees, the heating region amounts to approximately 80 arc degrees and the cooling region amounts to approximately 40 arc degrees. In accordance with this standard, an absolutely energy-saving operation can be kept up, as explained later in more detail.

In accordance with a further embodiment of the invention, the wheel drier is provided with one lid each at both axial ends. Each lid includes the connections for the air conducts. A wheel drier design of this type involves a linear through-flow for all air flows, as a result of which least pressure losses are given. In addition, the greatest possible cross-section is also used as active zone. As it is generally known, the residence time of the air should be longer and thus the flow velocity in the active zone minor. With this design of the wheel drier it is possible to fulfill these conditions.

In accordance with an embodiment of the invention, the two lids are stationary and a rotor disk with a seal, in particular a sandwich seal, is provided between the lids and the rotating drum. A seal of this type between the stationary and the rotating part of the wheel drier has proved its worth, as it unites low wear with sealing elasticity.

In accordance with a very special feature of the invention, the central region of the wheel drier is designed as hollow shaft with a heat exchanger function. With this intelligent design, it is possible to save energy and increase the efficiency, as explained later in more detail.

In accordance with an embodiment of the invention, a wire cloth or stainless steel wool or the like is provided in the hollow shaft designed as heat exchanger. Filling materials of this type have proved their worth for the heat exchanger function.

The aim of this invention is also to create a method for drying bulk goods that on the one hand avoids the disadvantages cited for the state of the art and on the other hand increases the economic efficiency in operation.

The method for drying bulk goods in accordance with the invention is characterized in that the drying or dehumidifying phase for the exhaust air flow and preferably the adsorbent cooling occur in parallel, in particular in a continuous manner during permanent operation, and the regenerating phase with the adsorbent heating is carried out at intervals during the operation. In this manner, the drum of the wheel drier is stopped in the cooling or regenerating phase and advanced to a selectable region, preferably the cooling region, after the cooling or regenerating phase finishes, and that the heating region is defined at least equal to or greater, preferably double the amount, than the cooling region. With this method in accordance with the invention, it is for the first time possible to minimize the energy consumption.

Zeolite requires a temperature of more than 200° C. for regenerating, thus for dehumidifying and drying. The higher the temperature was, the better the efficiency would be. Depending on temperature, time and air flow, a specific cost of energy is therefore necessary for regenerating a certain amount of zeolite. As a result, the optimal energy consumption can be determined based on the degree of humidity of the zeolite. An energy supply in excess of the saturation range is useless. However, there are limits to the height of the temperature in view of the temperature resistance of the machinery parts and components involved in the process, such as seals, which is at approximately 280° C.

As mentioned, the energy consumption of the drying process is determined very much by the heating output in the regenerating phase. The achievement of a constant dew point was in accordance with the methods belonging to the state of the art and their philosophy. In fulfillment of this requirement, the regenerating phase occurred during permanent operation.

In accordance with the philosophy underlying this invention, namely to at least maintain the quality standard of the drying air but increase the economic efficiency, a difference between heavily and less heavily loaded drying tasks is deliberately made in the drying method. Pursuant to the present method in accordance with the invention, the regenerating phase for less heavily loaded drying tasks is carried out at intervals during the operation as a result of this conclusion. This means that the heater for heating the adsorbent and, where applicable, the associated fan are switched off deliberately for a period of time. With this type of operation at intervals, the curve for the dew point deviates only insignificantly from the ideal curve, whereby however the deviation for the quality standard is unnoticeable.

Particularly in tropical areas, methods using cartridges for drying are out of favor due to the risk of leakage air. As a result, wheel driers of the type mentioned above are used in these areas. In order to thus be able to run wheel driers of this type even more economical in operation, the present method is applied. Wheel driers generally have the advantage that they operate independently and leakage-free.

In accordance with a special feature of the invention, the drying or dehumidifying region amounts to approximately 240 arc degrees, the heating region amounts to approximately 80 arc degrees and the cooling region amounts to approximately 40 arc degrees. Based on this definition of regions, thus to double the regenerating region in comparison with the cooling region, the possibility is created to reduce the regenerating output period or heating output by 50%. The regenerating phase is only put into operation every second cooling phase.

According to measurements in test operation, approximately 38% of the energy consumption of the system is saved using this economical method.

In accordance with another special feature of the invention, the air flow for cooling is branched off from the exhaust air flow after the drying or dehumidifying phase. As a result of this measure, the cooling effect can be improved due to the dry air. Possible re-humidification by outside air is avoided.

In accordance with a special embodiment of the invention, a central region of the wheel drier that is designed like a hollow shaft is used as heat exchanger, and a regeneration air flow required for regenerating the drying or adsorbing agent and produced in a regenerating fan is conducted through this hollow shaft before its entry into the wheel drier. This ingenious, innovative embodiment results in another minimization of the system's energy consumption.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

The figures show:

FIG. 1 a view of a wheel drier;

FIG. 2 schematics of the air conducts;

FIG. 3 a top view of the wheel drier with removed lid; and

FIG. 4 a section with cells of a drum of the wheel drier.

### DETAILED DESCRIPTION OF THE EMBODIMENTS

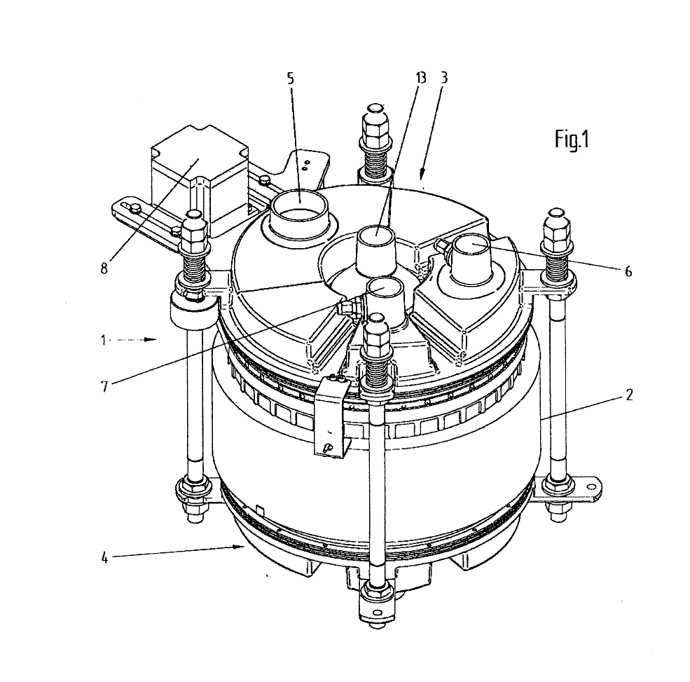

According to FIG. 1, the wheel drier 1 includes a rotatable drum 2 provided with one lid 3, 4 each at both axial ends, in which each lid 3, 4 includes the connections for the air conducts 5, 6, 7. The drum 2 is rotatable using a belt drive through a drive motor 8, such that the two lids 3, 4 are stationary. The central region of the wheel drier 1 is designed as hollow shaft and has the function of a heat exchanger 13.

The wheel drier 1 forms part of a device for drying bulk goods, in particular solids, such as granular materials, powders, grains, films, shreds, or the like, preferably plastic granular material. The device furthermore includes a drying silo 9, through which an air flow flows. The air conduction is illustrated schematically in FIG. 1. In order to dry, during the drying or dehumidifying phase 14, the exhaust air flow 5 or the returning air exiting the drying silo 9, the exhaust air flow 5 is connected by a filter 10 and a process fan 11 to the wheel drier 1 that contains a drying or adsorbing agent. The exhaust air flow 5 is dried in the wheel drier 1. The exhaust air flow 5 is reintroduced to the drying silo 9 as drying air flow 12.

The adsorbing agent is regenerated in the regenerating phase 15 and subsequently cooled in the cooling phase 16 in the wheel drier 1. For regenerating the adsorbent, the regenerating air flow 6 is conducted through the heat exchanger 13 by a filter 17 and a regenerating fan 18, heated up by a heater 19, and then introduced to the wheel drier 1. For subsequent cooling of the adsorbent, a part of the drying air flow 12 is branched off as air flow 7 for the cooling and introduced to the wheel drier 1.

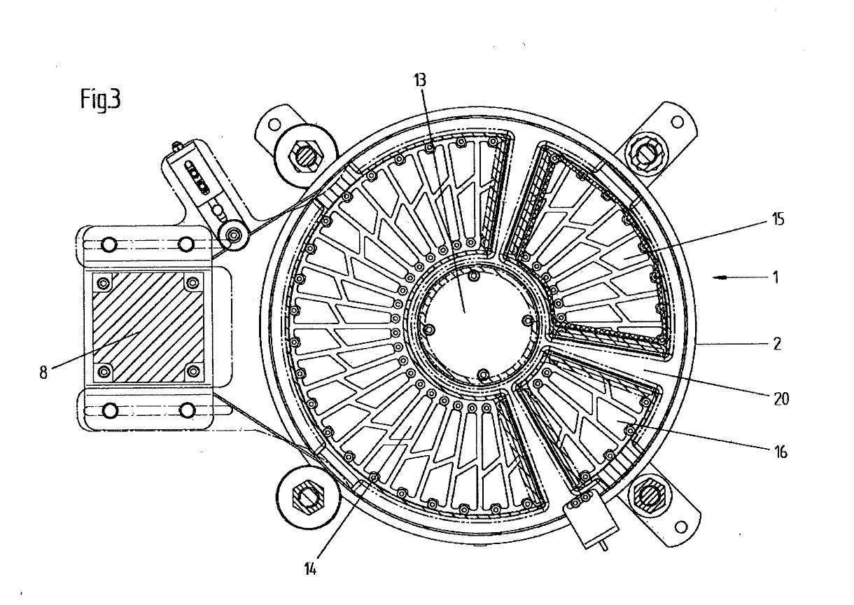

According to FIG. 3, the wheel drier 1 is shown open at the top, thus without lid 3. The drum 2 is rotated or advanced by the drive motor 8 and the belt drive. The wheel drier 1 or the drum 2 is divided into at least three wheel segments: the region of one wheel segment serves for drying or dehumidifying the exhaust air flow 5, i.e., the drying or dehumidifying phase 14; the region of the second wheel segment serves for heating the adsorbent, i.e., the regenerating phase 15; and the region of the third wheel segment serves for cooling the adsorbent, i.e., the cooling phase 16. The heat exchanger 13 is in the central region of the wheel drier 1. A wire cloth or stainless steel wool or the like can be provided in the hollow shaft designed as heat exchanger 13. The drying or dehumidifying region amounts to approximately 240 arc degrees, the heating region amounts to approximately 80 arc degrees and the cooling region amounts to approximately 40 arc degrees.

A rotor disk with a seal 20, in particular a sandwich seal, which serves as elastic compensating element, is provided between the lids 3, 4 and the rotating drum 2.

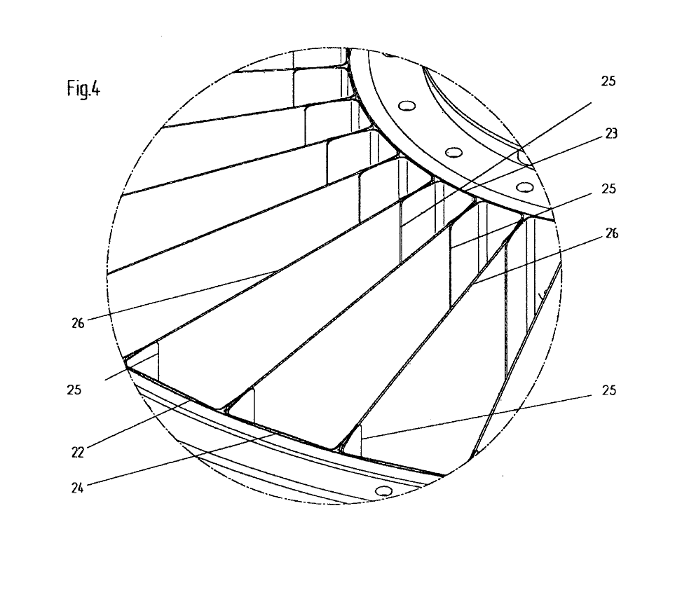

According to FIG. 4, the inner mechanism of the drum 2 is shown in a detailed view. The drum 2 is divided into individual cells 21, such that the individual cells 21 of the drum 2 of the wheel drier 1 are formed by plates. Clamping plates 24 having a U-shaped cross-section lie against the radial outer and inner jackets 22, 23 of the drum 2. The clamping plates 24 are arranged axially on the inner wall of the drum 2, thus against the outer jacket 22 and the inner jacket 23. The legs 25 of the U-shaped clamping plates 24 are tilted outwardly, so that they press against the adjacent legs 25 of the adjacent clamping plate 24 with tensile force after they are placed in the drum 2. Separating plates 26 are provided as partitions of the individual cells 21. The separating plates 26 are positioned by the clamping effect of adjacent legs 25 of two U-shaped clamping plates 24 lying against each other and seal off the cells from each other. In the exemplary embodiment, an amount of 36 cells are provided. Naturally, also three, for the three phases, or six cells 21 would be conceivable in an extreme case.

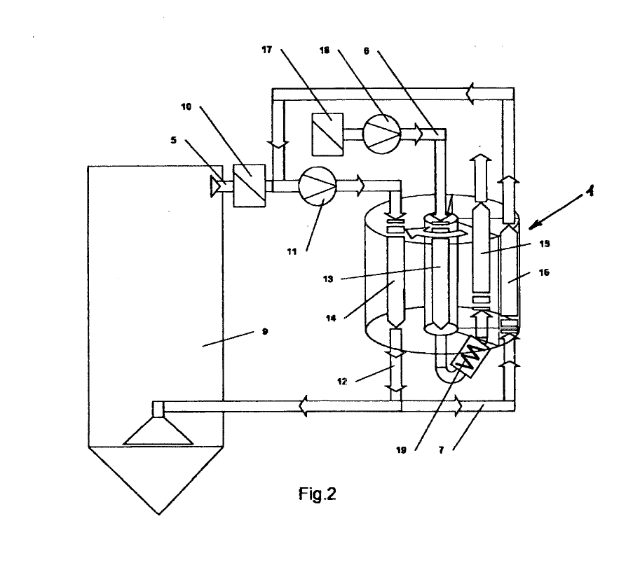

A method for drying bulk goods can be performed by using the device described above and which increases the economic efficiency of the overall system is explained below involving FIG. 2.

The drying or dehumidifying phase 14 for the exhaust air flow 5 is carried out in a continuous manner during the operation. Preferably, the cooling phase 16 of the adsorbent is also carried out in a continuous manner during the operation in parallel to the drying or dehumidifying phase 14. The regenerating phase 15 with the adsorbent heating is carried out at intervals during the operation.

Based on the design that the region for the regenerating phase 15 is at least equal to, preferably however greater than the region for the cooling phase 16, the heater 19 or the regenerating fan 18 can be switched off.

In the preferred embodiment, in which the regenerating region comprises twice as many cells 21 as the cooling region, the regenerating phase 15 can be shut down every second cooling period, as a result of which a saving of 50% of energy is achieved.

The drum 2 of the wheel drier 1 is always stopped in the cooling 16 or regenerating phase 15 and advanced to the cooling region after the cooling 16 or regenerating phase 15 finishes.

This process is illustrated for a drum 2 with 36 cells 21 in accordance with the following Table 1.

The advance cycle of the drum 2 once by five and the next by four cells 21 results from the fact that the bordering cells between the individual phases in the drum 2 are not located in the active zone (see FIG. 3).

TABLE 1

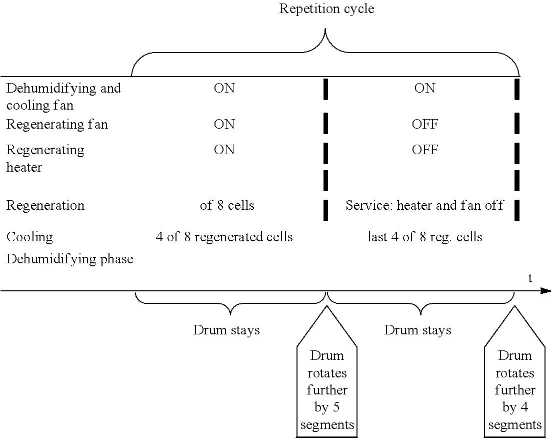

1.-12. (canceled)

13. A device for drying bulk goods, comprising:
a drying silo structured and arranged for an air flow to flow through;
a process fan arranged to couple the drying silo to a wheel dryer comprising a drying or adsorbing agent and a rotatable drum having radial cells, to direct exhaust air flow exiting the drying silo or returning air from the wheel dryer into the wheel dryer, and to reintroduce the cooled exhaust air flow to the drying silo as drying air flow;
the wheel dryer being structured and arranged to regenerate and subsequently cool the drying and adsorbing agent;
the rotatable drum having a radial outer and inner jackets and individual cells formed by clamping plates having a U-shaped cross-section lying against the radial outer and inner jackets and by separating plates arranged as partitions,
wherein some of the clamping plates are arranged axially on the inner wall so that legs of the U-shaped cross-section are tilted outwardly to generate a clamping effect between adjacent legs of adjacent clamping plates to attach the separating plates and to seal the cells from each other.

14. The device in accordance with claim 13, wherein the bulk goods comprise at least one of granular materials, powders, grains, films, shreds, and plastic granular material,

15. The device in accordance with claim 13, wherein the rotatable drum comprises at least three cells.

16. The device in accordance with claim 15, wherein the at least three cells comprises six cells.

17. The device in accordance with claim 15, wherein the at least three cells comprises 36 cells.

18. The device in accordance with claim 13, wherein the wheel dryer is divided into at least three wheel segments, such that a region of a first wheel segment is structured and arranged for drying or dehumidifying the exhaust air flow, a region of a second wheel segment is structured and arranged for heating the drying or adsorbing agent, and a region of a third wheel segment is structured and arranged for cooling the drying or adsorbing agent.

19. The device in accordance with claim 18, wherein the drying or dehumidifying region comprises approximately 240 arc degrees, the heating region comprises approximately 80 arc degrees and the cooling region comprises approximately 40 arc degrees.

20. The device in accordance with claim 13, wherein the drying cell comprises a wheel dryer having a lid arranged at each axial end, and each lid comprises connections for receiving air flows.

21. The device in accordance with claim 20, wherein the lids are structured and arranged to be stationary, and a rotor disk with a seal is arranged between the lids and the rotating drum.

22. The device in accordance with claim 21, wherein the seal comprises a sandwich seal.

23. The device in accordance with claim 13, wherein the drying cell comprises a wheel dryer having a hollow shaft in a central region structured and arranged as heat exchanger.

24. The device in accordance with claim 23, further comprising at least one of wire cloth or stainless steel wool within the hollow shaft.

25. A method for drying bulk goods in the device accordance to claim 1, the method comprising:
drying at least one of exhaust air flow or returning air flow and cooling the drying or adsorbing agent occur in a parallel operation;
heating the drying or adsorbing agent at intervals during the operation to regenerate the drying or adsorbing agent;
rotating the drum to a selected region to one of regenerate or cool the drying or adsorbing agent; and
advancing the drum to a next region after the regenerating or cooling is completed.

26. The method in accordance with claim 25, wherein the parallel drying of the at least one of exhaust air flow or returning air flow and cooling of the drying or adsorbing agent is performed in a continuous manner during operation.

27. The method in accordance with claim 25, wherein the wheel dryer is divided into at least three wheel segments, such that a region of a first wheel segment is structured and arranged for drying or dehumidifying the exhaust air flow, a region of a second wheel segment is structured and arranged for heating the drying or adsorbing agent, and a region of a third wheel segment is structured and arranged for cooling the drying or adsorbing agent.

28. The method in accordance with claim 27, wherein the drying or dehumidifying region amounts to approximately 240 arc degrees, the heating region amounts to approximately 80 arc degrees and the cooling region amounts to approximately 40 arc degrees.

29. The method in accordance with claim 25, further comprising branching off a portion of the dried exhaust air as an air flow for cooling the drying or adsorbing agent.

30. The method in accordance with claim 25, wherein the dryer wheel comprises a hollow shaft in a central region formed as a heat exchanger, and the method further comprises:
producing a regeneration air flow for regenerating the drying or adsorbing agent; and
conducting the regeneration air flow through the hollow shaft before entry into the drying cell.
